(19) United States
(12) Patent Application Publication
(10) Pub. No.: US 2026/0364847 A1
(43) Pub. Date: Nov. 19, 2026

(54) 3D CONCRETE PRINTHEAD

(71) Applicant: MAI INTERNATIONAL GMBH, Feistritz/Drau (AT)

(72) Inventors: Hannes PAPOUSEK, Landskron (AT); David KAMPITSCH, Paternion (AT); Volker Emil RUITINGA, Eindhoven (NL); Klaus KAMPITSCH, Kamering (AT); Marc SEPPELE, Feistritz/Drau (AT); Manuel DIDL, Feistritz/Drau (AT); Sebastian ALTERSBERGER, Bad Bleiberg (AT)

(21) Appl. No.: 19/121,874

(22) PCT Filed: Oct. 20, 2022
(86) PCT No.: PCT/EP2022/079257

§ 371 Date: Apr. 17, 2025

(51) Int. Cl. B28B 1/00; B33Y 30/00; B33Y 40/10

(52) U.S. Cl. CPC B28B 1/001; B33Y 30/00; B33Y 40/10

(57) ABSTRACT

The invention relates to a 3D concrete printhead (10) for two-or multi-component materials, comprising
a housing (12) and a mixing chamber (14) arranged therein and delimited by a housing wall (16),
a material supply line (34) with a material supply opening (19), which feeds into the mixing chamber (14),
at least one additive line (36) with an end section (38) arranged in the material supply line (34),
an actively driveable mixing unit arranged in the mixing chamber (14),
a mixing chamber outlet opening (20), wherein the mixing chamber (14) extends along a longitudinal axis (L) at least between the material supply opening (19) and the mixing chamber outlet opening (20), and
a discharge opening (32) that is fluidically connected to the mixing chamber outlet opening (20).

In order to achieve improved mixing quality, the at least one additive line (36) feeds via an additive opening (40) into the material supply line (34), wherein the additive opening (40) is located upstream of the material supply opening (19) and is spaced apart from the housing wall (16) of the mixing chamber (14) by a distance (X).

The present invention relates to a 3D concrete printhead for two-or multi-component materials. The materials which can be processed with such a 3D concrete printhead can be concrete, mortar or geopolymers as well as mixtures of these materials. For example, dry mortars premixed at the factory can be used, which dry mortars may also contain geopolymers. The expression “3D concrete printhead” used within the context of this description is therefore not to be understood as meaning that only concrete can be processed with the 3D concrete printhead. Rather, this expression is to be understood as meaning that it includes processing of the materials mentioned above.

A 3D concrete printhead must enable the continuous delivery of an intensively mixed two-or multi-component material, in order to ensure consistent material properties of the material delivered by the 3D concrete printhead. Otherwise, there would be the risk that a component produced by the 3D concrete printing process may randomly exhibit different material properties, depending on the location. Furthermore, a 3D concrete printhead should be as compact and as lightweight as possible in order that it can be moved and in particular also pivoted quickly and precisely, for example by means of a robotic arm.

In order to achieve desired properties of the material delivered by a 3D concrete printhead, an additive is usually added to the concrete or mortar or the like forming the material base. Depending on the desired material properties, multiple additives may also be used. Such additives are, for example, hardening accelerators or retarders, coloring pigments, and/or substances which influence the rheological properties of the material to be processed. Such substances may be so-called plasticizers, which change the thixotropy of the material to be processed, or flow aids, which make a material mixture to be processed more flowable.

Regardless of the exact nature of the additive(s) used, it is important in a 3D concrete printhead to intimately mix the additive(s) with the concrete, mortar or the like forming the material base before the material as a whole is delivered from the 3D concrete printhead. DE 10 2020 003 760 A1 discloses a 3D concrete printhead in which it is to be ensured that the concrete or mortar base material is intimately mixed in the mixing chamber of the 3D concrete printhead with additives that are used by introducing the concrete or mortar base material and an additive or multiple additives into the mixing chamber simultaneously but separately from one another through a common opening in a circumferential wall of the mixing chamber. In this way, the entire length of the mixing chamber is available for intimately mixing the materials introduced into the mixing chamber with one another.

The object underlying the invention is to provide a 3D concrete printhead which ensures intimate mixing of the materials that are used and is of a more simple construction than the 3D concrete printhead known from DE 10 2020 003 760A1.

Starting from the mentioned prior art, this object is achieved according to the invention by a 3D concrete printhead having the features of patent claim 1. The 3D concrete printhead according to the invention is so designed that the concrete or mortar base material and the additive(s) that is/are used can be brought into contact with one another and mixed before they enter the mixing chamber. In order to achieve this, an additive line, the end portion of which is arranged in a material supply line leading into the mixing chamber, opens through an additive opening into the above-mentioned material supply line, wherein the additive opening is located upstream of a material supply opening through which the material supply line opens into the mixing chamber. The additive opening is thus not arranged, as in the mentioned prior art, in the material supply opening of the mixing chamber circumferential wall but is set back into the material supply line and thus spaced apart from the housing wall of the mixing chamber. The distance of the additive opening from the housing wall, or the material supply opening, should be at least approximately as great as the diameter of the material supply opening, but it may also be significantly greater. The much smaller volume of the material supply line in relation to the mixing chamber allows better and more rapid mixing of the additive or additives with the concrete or mortar base material in the material supply line and therefore makes it possible for the length of the mixing chamber to be shortened compared to the prior art, while the diameter remains the same. Within the context of the object to be achieved, this results in a more compact and also more lightweight 3D concrete printhead which, despite its more compact construction, is able to deliver a better mixing quality.

The additive line can consist, for example, of metal or of plastics material. The additive line, in particular the end portion thereof, is preferably provided with a lining, which counteracts accumulations of material. Such a lining can consist, for example, of polytetrafluoroethylene (Teflon®). If the entire additive line or at least the end portion thereof consists of such a friction-reducing material, it is not necessary to line the additive line or the end portion. The end of the additive line can further be of nozzle-like form or be provided with a nozzle in order to increase the inflow speed of the additive(s) into the material supply line and thus achieve even better initial mixing of the additive(s) with the material already flowing in the material supply line.

According to one embodiment of the 3D concrete printhead according to the invention, the additive line can comprise two or more channels, each of which opens via an associated additive opening into the material supply line. In this way, two or more additives can be fed into the material supply line by a single additive line. Regardless of whether the additive line comprises only a single channel or a plurality of channels, the end portion of the additive line is preferably arranged concentrically with the material supply line, that is to say the cross section of the material supply line and the cross section of the additive line have a common center.

Regardless of whether the end portion of the additive line is or is not arranged concentrically with the material supply line, it can be provided that the end portion of the additive line is mounted to be axially displaceable, so that the distance of the additive opening (or of the additive openings if there is a plurality of channels in the additive line) from the housing wall of the mixing chamber can be varied. In this way, the section available for mixing and homogenization in the material supply line up to the entry into the mixing chamber can be lengthened or shortened and thus adapted to the mixing properties of the additive(s) used.

In order to enhance the mixing quality even when the section available for mixing and homogenization in the material supply line is only short, there is in some embodiments of the 3D printhead according to the invention a flow cross section constriction in the material supply line downstream of the additive opening and upstream of the material supply opening. Such a flow cross section constriction can in particular have the form of a Laval nozzle. The flow cross section constriction leads to a locally increased flow speed in the material supply line and thus to more intensive mixing of the additive(s) with the concrete or mortar base material in the material supply line. Alternatively or in addition, there can be a static mixer in the material supply line downstream of the additive opening and upstream of the material supply opening, said static mixer likewise leading to more intensive mixing of the additive(s) and the concrete or mortar base material in the material supply line.

It has already been explained above that an additive line can comprise two or more channels in order that multiple additives can be fed into the material supply line. Alternatively or in addition, a plurality of additive lines, the end portions of which are each located in the material supply line, can be so arranged that they open with their additive openings into the material supply line. The plurality of additive lines can open into the material supply line at the same point, as seen in the flow direction of the material supply line. The end portions of the plurality of additive lines can be arranged axially in the material supply line or project radially into the material supply line and be arranged offset relative to one another in the circumferential direction of the material supply line. For example, the end portions of the plurality of additive lines can project radially into the material supply line such that their additive openings are located close to the center of the material supply line. All the additives fed into the material supply line through such additive lines then meet in the core region of the flow running through the material supply line and thus, immediately after they have been fed in, are intensively mixed with one another and with the concrete or mortar base material flowing in the material supply line.

Alternatively, the end portions of the plurality of additive lines can project tangentially into the material supply line, wherein they can likewise be arranged offset relative to one another in the circumferential direction of the material supply line. By feeding additive(s) tangentially into the material supply line in this manner, a swirling motion can be imparted to the flow flowing in the material supply line, said swirling motion intensifying mixing and thus enhancing the mixing quality. Embodiments are also possible in which some end portions of the plurality of additive lines project radially into the material supply line and other end portions of the plurality of additive lines project tangentially into the material supply line.

Depending on the properties of the additives that are used, it may be advantageous not to feed the additives or not to feed all the additives into the material supply line at the same point, as seen in the flow direction of the material supply line. This is the case, for example, if some additives are not readily compatible with one another and therefore must first be mixed individually with the concrete or base material. In order to achieve this aim, some embodiments of the 3D concrete printhead according to the invention are distinguished in that the additive openings of the plurality of additive lines are arranged one behind the other, as seen in the flow direction of the material supply line. The additive openings of the plurality of additive lines are thus axially spaced apart from one another in the material supply line. As already explained above, the end portions of the plurality of additive lines can project radially or tangentially into the material supply line and preferably be arranged offset relative to one another in the circumferential direction of the material supply line.

In other embodiments of the 3D concrete printhead according to the invention having a plurality of additive lines, the end portions of the plurality of additive lines are arranged axially and one behind the other in the material supply line. It is thus likewise achieved that the additive openings of the plurality of additive lines are axially spaced apart from one another in the material supply line. In the last-mentioned embodiment, there can be a static mixer or a flow cross section constriction between two additive openings of the plurality of additive lines, said additive openings following one another in the flow direction of the material supply line, in order to intensify the mixing and homogenization process and thus improve the mixing quality. As already explained, the flow cross section constriction can in particular have the form of a Laval nozzle.

Owing to its many possible variants, the form of the 3D concrete printhead according to the invention can specifically be matched to any intended use and to any material combination to be processed. In addition, the 3D concrete printhead according to the invention in any embodiment ensures excellent mixing and homogenization of the material that is used and, owing to its compact and more lightweight construction, is very easy to handle, which in particular reduces the demands to be made of handling robots.

Embodiments of the 3D concrete printhead according to the invention will be explained in greater detail hereinbelow with reference to the exemplary, schematic drawings, in which:

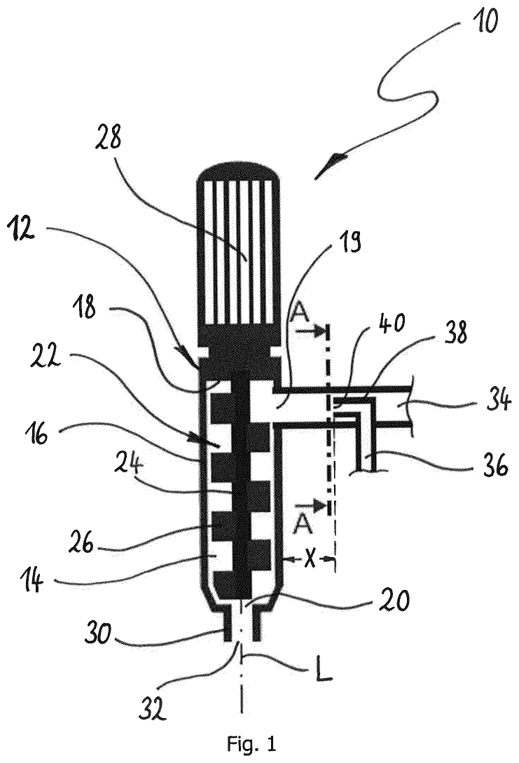

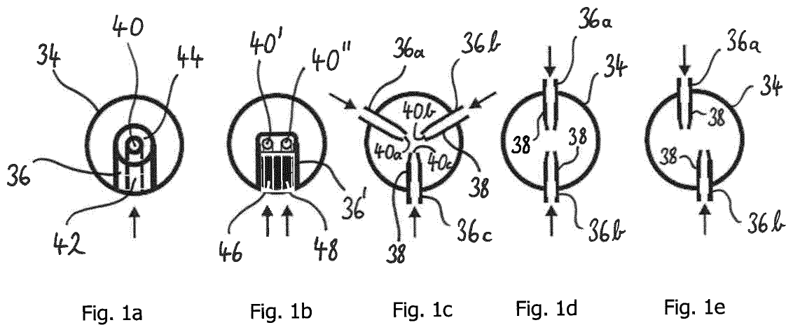

FIG. 1 shows a partial longitudinal section through a first embodiment of a 3D concrete printhead according to the invention,

FIG. 1a shows view A-A from FIG. 1 with an additive line comprising one channel and

FIG. 1b shows view A-A from FIG. 1 with an additive line comprising two channels and arranged concentrically in the material supply line,

FIG. 1c shows view A-A from FIG. 1 with three additive lines arranged offset in the circumferential direction and projecting radially into the material supply line,

FIG. 1d shows view A-A from FIG. 1 with two additive lines arranged opposite one another and projecting radially into the material supply line,

FIG. 1e shows view A-A from FIG. 1 with two additive lines arranged opposite one another and projecting tangentially into the material supply line,

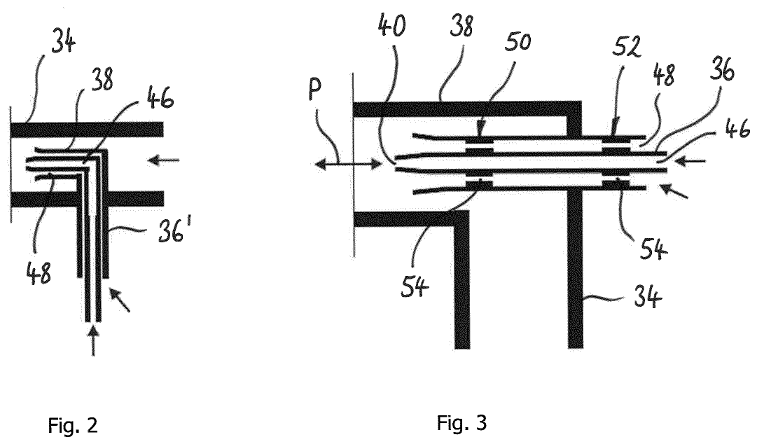

FIG. 2 shows a detail view of a modification of the embodiment shown in FIG. 1,

FIG. 3 shows a detail view of a further modification of the embodiment shown in FIG. 1,

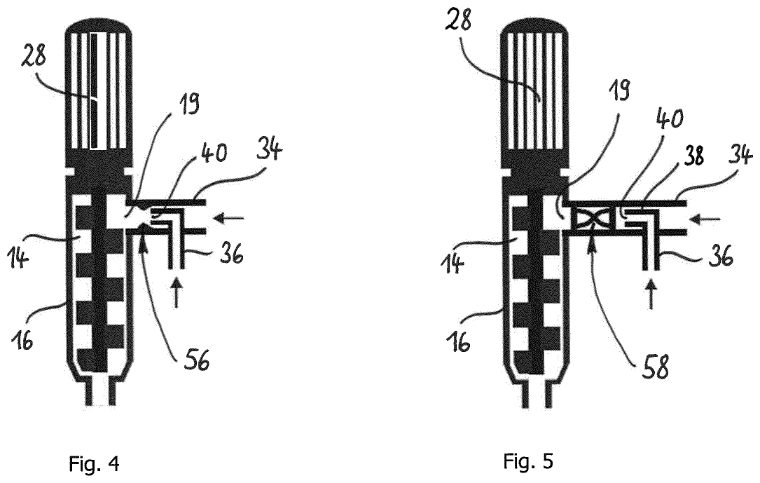

FIG. 4 shows a partial longitudinal section through an embodiment having a flow cross section constriction in the material supply line,

FIG. 5 shows a partial longitudinal section through an embodiment having a static mixer in the material supply line,

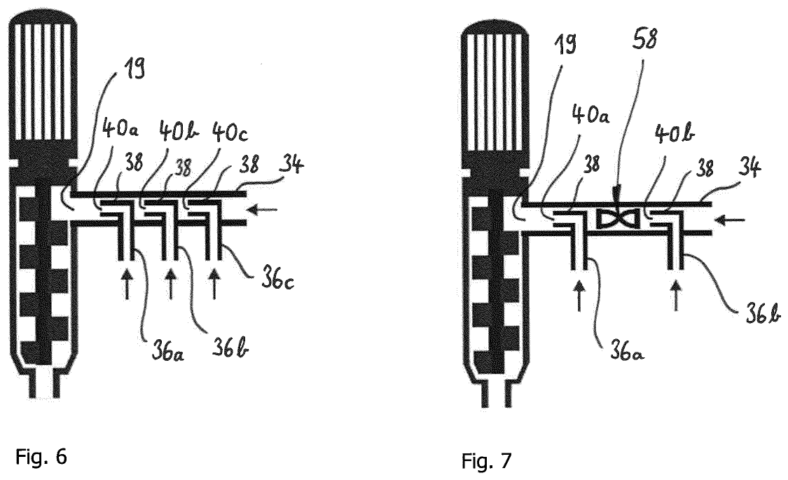

FIG. 6 shows a partial longitudinal section through an embodiment having three additive lines arranged axially one behind the other in the material supply line, and

FIG. 7 shows a partial longitudinal section through an embodiment having two additive lines arranged axially one behind the other in the material supply line and having a static mixer arranged between them.

FIG. 1 shows a first embodiment of a 3D concrete printhead 10 for dispensing concrete, mortar or the like, in a partially longitudinally cutaway view. The 3D concrete printhead 10 has a housing 12 with a mixing chamber 14 arranged therein, said mixing chamber being delimited by a housing wall 16. The expressions “at the top”, “above”, “at the bottom”, “beneath” and “at the side” used in connection with the accompanying figures are not to be interpreted as being absolute but relate simply to the representation of the 3D concrete printhead 10 shown in the figures. It will be appreciated that a 3D concrete printhead 10 can assume any desired and necessary orientation while it is operating.

In the embodiments shown, the mixing chamber 14 is of circular-cylindrical form and may therefore also be referred to as a mixing pipe.

The mixing chamber 14 extends in the axial direction along a longitudinal axis L from an end 18 of the mixing chamber 14, said end being at the top in the figures, to a bottom end, which is formed by a mixing chamber outlet opening 20. In particular, the mixing chamber 14 extends between a material supply opening 19, which here is arranged at the side, and the mixing chamber outlet opening 20. The material supply opening 19 serves for introducing the concrete, mortar or the like into the mixing chamber 14. Although the material is introduced into the mixing chamber 14 in a circumferential region of the housing wall 16 in all the embodiments shown here, it is also possible to arrange for the material to be introduced in an end region of the housing wall 16, for example at the top end 18 of the mixing chamber 14 (not shown). The top end 18 of the mixing chamber 14 may have to be widened slightly compared to the embodiments shown in order to create sufficient space at the top end 18 of the mixing chamber 14 for a material supply opening 19.

In the mixing chamber 14 there is an actively driveable mixing device, here in the form of a mixer 22 having a mixing shaft 24 which extends axially through the mixing chamber 14 and to which there are attached a plurality of radially outwardly projecting mixing blades 26. An electric motor is connected to the top end of the mixing shaft 24 and serves to drive the mixing shaft 24 and thus the mixer 22 as a whole in rotation in order to allow the mixing shaft 24 to rotate about the longitudinal axis L. Instead of the electric motor 28 shown here, the mixing shaft 24 may also be driven mechanically, pneumatically or hydrodynamically in a different way. The mixer 22 shown is likewise to be regarded only as an example. Instead of the mixer 22 shown, any other mixer or any other mixing device with which desired mixing can be achieved in the mixing chamber 14 may be used.

Beneath the mixing chamber 14 there is arranged a discharge component 30, which at its bottom, free end forms a discharge opening 32 of the 3D concrete printhead 10. In the embodiments shown here, the discharge component 30 is in each case fastened to the housing 12 and can have a flow cross section which tapers conically in the flow direction. As shown, the mixing chamber outlet opening 20 of the mixing chamber 14 is fluidically connected to the discharge component 30 and thus also to the discharge opening 32, so that, when the 3D concrete printhead 10 is operating, material can be dispensed from the mixing chamber 14 through the discharge opening 32.

In order to allow material that is to be dispensed to be introduced into the mixing chamber 14, the material supply opening 19 of the mixing chamber 14 is connected to a material supply line 34, which extends outward from the material supply opening 19 and which can be in the form of, for example, a supply pipe and/or a supply hose. The main constituents of a material mixture that is to be dispensed by the 3D concrete printhead are supplied to the mixing chamber 14 through the material supply line 34. For example, the material supply line 34 can be connected directly to a concrete or mortar mixing device (not shown), the concrete or mortar mixing device producing concrete or mortar or the like and pushing it through the material supply line 34 into the mixing chamber 14 of the 3D concrete printhead 10.

For the successful application of a 3D concrete printing process, it is generally necessary to add one or more further substances to the material to be processed, which is supplied to the mixing chamber 14 through the material supply line 34, in order to precisely adjust the properties of the material mixture to be dispensed by the 3D concrete printhead 10. These further substances are here referred to as additives.

For introducing such further substances into the material that is to be processed by the 3D concrete printhead 10 there is used at least one additive line 36 having an end portion 38 arranged in the material supply line 34. The end portion 38 has an additive opening 40, through which the additive line 36 opens directly into the material supply line 34. In order that an additive supplied through such an additive line 36 can mix with the material flowing through the material supply line 34 even before said additive enters the mixing chamber 14, the additive opening 40 is arranged before the material supply opening 19, as seen in the flow direction of the material flowing through the material supply line 34. In other words, the additive opening 40 is located upstream of the material supply opening 19 at a distance X from the housing wall 16 of the mixing chamber 14. This distance X is such that the material flowing through the material supply line 34 (which now includes the additive or additives) is sufficiently thoroughly mixed in this section X even before it enters the mixing chamber 14. The distance X should be at least approximately as great as the diameter of the material supply opening 19, but the distance X may also be a multiple of the diameter of the material supply opening 19, for example twice, three times, four times or five times the mentioned diameter. Even greater distances X are in principle also possible. In the mixing chamber 14, the material mixture entering through the material supply opening 19 is then further mixed and homogenized.

In the exemplary embodiment shown in FIG. 1, the additive line 36 enters the material supply line 34 at the side and is then so guided that the end portion 38 of the additive line 36 is oriented axially within the material supply line 34, that is to say in the flow direction of the material flowing in the material supply line 34. The additive line 36 can, however, also be guided into the material supply line 34 in another way than that shown, for example from behind (not shown).

FIGS. 1a to 1e each show view A-A from FIG. 1 for different configurations of the arrangement of one or more additive lines 36 in the material supply line 34. FIG. 1a corresponds substantially to the embodiment shown in FIG. 1, in which the additive line 36 comprises only a single channel 42 for supplying an additive into the material supply line 34. According to this exemplary embodiment, the end portion 38 of the additive line 36 is arranged concentrically with the cross section of the material supply line 34, that is to say an end face 44 of the end portion 38, said end face comprising the additive opening 40, and the cross section, which here is circular, of the material supply line 34 have the same center. However, the end portion 38 of the additive line 36 does not necessarily have to be arranged centered in the material supply line 34 in this way but may also be arranged eccentrically in the material supply line 34 (not shown). The material supply line 34 also does not need to have a circular cross section.

FIG. 1b shows an exemplary embodiment similar to FIG. 1a but, in contrast to FIG. 1a, the additive line 36′ has a rectangular cross section instead of a circular cross section.

Furthermore, the additive line 36′ contains two channels 46, 48 each having an additive opening 40′, 40″, so that, according to this embodiment, two additives can be introduced into the material supply line 34. The end portion 38 of the additive line 36′, analogously to FIG. 1, is oriented axially in the material supply line 34 and centered on the center of the cross section of the material supply line 34. As explained above in relation to FIG. 1a, an eccentric arrangement is also possible here (not shown).

FIG. 1c illustrates another exemplary embodiment, in which three additive lines 36a, 36b and 36c each project radially with their associated end portions 38 into the material supply line 34. The additive lines 36a, 36b, 36c are arranged offset relative to one another, in the exemplary embodiment in each case offset by 120°relative to one another, in the circumferential direction of the material supply line 34, but they all open into the material supply line 34 at the same point, as seen in the axial direction of the material supply line 34. According to FIG. 1c, three different additives can be introduced into the material supply line 34 into the core of a flow which is flowing in the material supply line 34, these three additives, as a result of meeting one another, immediately mixing with one another after emerging from the associated additive line 36a, 36b, 36c through the additive opening 40a, 40b or 40c. According to a modified embodiment which is not shown here, the additive lines 36a, 36b, 36c are arranged offset in the axial direction of the material supply line 34 and then no longer open into the material supply line 34 at the same point. An offset of the additive lines 36a, 36b, 36c in the circumferential direction of the material supply line 34 can likewise be provided in this modified embodiment, but may also be omitted.

FIG. 1d shows a configuration similar to FIG. 1c with only two additive lines 36a, 36b, which according to this exemplary embodiment are arranged opposite one another. An arrangement of the additive lines 36a, 36b so that they are not opposite one another is likewise possible (not shown). Otherwise, the explanations given in relation to FIG. 1c apply analogously, that is to say the two additive lines 36a, 36b can open into the material supply line 34 at the same point with respect to the axial direction of the material supply line 34 or at axially spaced apart points.

FIG. 1e shows a further modified embodiment, in which the end portions 38 of two additive lines 36a, 36b project tangentially into the material supply line 34 and are arranged offset relative to one another in the circumferential direction of the material supply line 34. In the case of such a tangential arrangement of the end portions 38 of the additive lines 36a and 36b, the additives introduced no longer collide directly with one another in the core of a flow flowing through the material supply line 34. Instead, such a tangential arrangement of the end portions 38 with respect to the cross section of the material supply line 34 imparts a swirling motion to the flow in the material supply line 34, said swirling motion promoting thorough mixing of the additives that have been introduced both with one another and with the material in the material supply line 34. As already explained above, the end portions 38 can here too be arranged at the same point of the material supply line 34, as seen axially, or can be axially spaced apart from one another. Instead of the two additive lines 36a and 36b shown in FIG. 1e, a plurality of additive lines with such a tangential arrangement may also be present, in particular when the points of introduction into the material supply line 34 are axially spaced apart from one another, and it is of course also possible for only a single additive line with a tangential arrangement to be present. In addition, the embodiments shown in FIG. 1c to FIG. 1e can be combined with one another, that is to say some additive lines can open into the material supply line 34 at the same axial point and other additive lines can be axially spaced apart from this axial point and, if desired, also from one another. Also, some end portions 38 of the additive lines can have a tangential arrangement as illustrated in FIG. 1e and other end portions can be arranged radially. A combination with the exemplary embodiments shown in FIG. 1a and FIG. 1b is also possible, that is to say, for example, one or also two additives can be introduced into the material supply line 34 through the arrangements shown in FIG. 1a or FIG. 1b, while further additives are supplied via arrangements as are illustrated in FIGS. 1c to 1e.

FIG. 2 shows a further configuration of an additive line 36′, the arrangement of which corresponds in principle to the arrangement shown in FIG. 1. Like the additive line 36′ shown in FIG. 1b, the additive line shown in FIG. 2 also comprises two channels 46, 48, but in the case of the configuration shown in FIG. 2 these channels 46 and 48 are arranged concentrically with one another. The channel 46 has a circular flow cross section, whereas the channel 48 has an annular flow cross section.

FIG. 3 shows a modified embodiment compared to FIG. 2, in which the end portion 38 of the additive line 36 is mounted to be axially displaceable. As indicated by the arrow P, the distance X of the additive opening 40 from the housing wall 16, or the material supply opening 19, can thus be changed. It is thus possible to adapt the distance X, at least within certain limits, to the mixing property of a supplied additive and to provide such an additive, for example, with a longer section X for mixing with the material flowing in the material supply line 34. If a bearing arrangement 50, 52 is provided with through-flow openings 54 as shown in FIG. 3, the space concentrically surrounding the additive line 36 can then be used as in the embodiment according to FIG. 2 for supplying a further additive into the material supply line 34.

FIG. 4 shows an arrangement similar to the embodiment shown in FIG. 1 with a flow cross section constriction in the material supply line 34, said flow cross section constriction being arranged downstream of the additive opening 40 and upstream of the material supply opening 19. In the exemplary embodiment shown, the flow cross section constriction has the form of a Laval nozzle 56. Any flow cross section constriction, but in particular a Laval nozzle, leads to an increase in the flow speed in the region of the flow cross section constriction, whereby mixing of an additive supplied through the additive line 36 with the material flowing in the material supply line 34 is intensified. If the Laval nozzle 56 is arranged, as shown, close to the material supply opening 19, an accelerated inflow of the material mixture flowing in the material supply line 34 into the mixing chamber 14 is also achieved by such a Laval nozzle, which likewise contributes to better mixing.

FIG. 5 shows a modified embodiment in which, instead of the Laval nozzle 56 shown in FIG. 4, a static mixer 58 is arranged in the material supply line 34 downstream of the additive opening 40 and upstream of the material supply opening 19. Such a static mixer leads, over a relatively short section, to intimate mixing of the additive fed into the material supply line 34 with the material already flowing in the material supply line 34.

FIG. 6 shows an embodiment similar to FIG. 1, but, according to FIG. 6, three additive lines 36a, 36b, 36c are so arranged that their end portions 38 are arranged in the material supply line 34 axially and one behind the other. In other words, the end portions 38 follow one another in the axial direction, as seen in the flow direction of the material supply line 34.

Finally, FIG. 7 shows an embodiment similar to FIG. 6 with only two additive lines 36a and 36b, a static mixer 58 being arranged between the two additive openings 40b and 40a of the additive lines 36b and 36a, said additive openings following one another in the flow direction of the material supply line 34, in order to effect intimate mixing of an additive introduced through the additive line 36b with the material flowing in the material supply line 34. Such a static mixer, or alternatively a flow cross section constriction, can of course also be used in the embodiment shown in FIG. 6, optionally also several times, that is to say after one or a plurality or all of the additive openings 40a, 40b and 40c.

1. A 3D concrete printhead for two-or multi-component materials, comprising:
a housing and a mixing chamber arranged therein and delimited by a housing wall,
a material supply line having a material supply opening, which opens into the mixing chamber,
at least one additive line having an end portion arranged in the material supply line,
an actively driveable mixing device arranged in the mixing chamber,
a mixing chamber outlet opening wherein the mixing chamber extends along a longitudinal axis at least between the material supply opening and the mixing chamber outlet opening, and
a discharge opening fluidically connected to the mixing chamber outlet opening,
wherein
the at least one additive line opens through an additive opening into the material supply line, wherein the additive opening is located upstream of the material supply opening and is at a distance from the housing wall of the mixing chamber.

2. The 3D concrete printhead of claim 1, wherein the additive line comprises two or more channels, each of which opens via a different additive opening into the material supply line.

3. The 3D concrete printhead of claim 1, wherein an end portion of the additive line is arranged concentrically with the material supply line.

4. The 3D concrete printhead of claim 1, wherein an end portion of the additive line is mounted to be axially displaceable, so that the distance of the additive opening from the housing wall of the mixing chamber is variable.

5. The 3D concrete printhead of claim 1, further comprising a flow cross section constriction, in the material supply line downstream of the additive opening and upstream of the material supply opening.

6. The 3D concrete printhead of claim 1, further comprising a static mixer in the material supply line downstream of the additive opening and upstream of the material supply opening.

7. The 3D concrete printhead of claim 1, wherein the at least one additive line comprises a plurality of additive lines each having a respective end portion arranged in the material supply line with a respective additive opening open into the material supply line.

8. The 3D concrete printhead of claim 7, wherein the plurality of additive lines each open into the material supply line at the same point, along a flow direction of the material supply line.

9. The 3D concrete printhead of claim 8, wherein the respective end portions of the plurality of additive lines project radially into the material supply line and are arranged offset relative to one another in a circumferential direction of the material supply line.

10. The 3D concrete printhead of claim 8, wherein the respective end portions of the plurality of additive lines project tangentially into the material supply line and are arranged offset relative to one another in a circumferential direction of the material supply line.

11. The 3D concrete printhead of claim 7, wherein the respective additive openings of the plurality of additive lines are arranged one behind the other, along a flow direction of the material supply line.

12. The 3D concrete printhead of claim 11, wherein the respective end portions of the plurality of additive lines project radially or tangentially into the material supply line and are arranged offset relative to one another in a circumferential direction of the material supply line.

13. The 3D concrete printhead of claim 7, wherein the respective end portions of the plurality of additive lines are arranged axially and one behind the other in the material supply line.

14. The 3D concrete printhead of claim 13, further comprising a static mixer or a flow cross section constriction arranged in the material supply line between two of the respective additive openings of the plurality of additive lines, said two of the respective additive openings following one another in a flow direction of the material supply line.

15. The 3D concrete printhead of claim 14, wherein the flow cross section constriction is in the form of a Laval nozzle.

16. A 3D concrete printhead for two-or multi-component materials, comprising:
a housing and a mixing chamber arranged therein and delimited by a housing wall,
a material supply line having a material supply opening that opens into the mixing chamber,
at least one additive line that opens through an additive opening into the material supply line, the additive opening being located upstream of the material supply opening,
a mixer arranged in the mixing chamber, and
a mixing chamber outlet opening, the mixing chamber extending along a longitudinal axis at least between the material supply opening and the mixing chamber outlet opening.

17. The 3D concrete printhead of claim 16, further comprising a flow cross section constriction in the material supply line downstream of the additive opening and upstream of the material supply opening.

18. The 3D concrete printhead of claim 16, further comprising a static mixer in the material supply line downstream of the additive opening and upstream of the material supply opening.

19. A 3D concrete printhead for two-or multi-component materials, comprising:
a housing and a mixing chamber arranged therein and delimited by a housing wall,
a material supply line having a material supply opening, which opens into the mixing chamber,
at least one additive line having an end portion arranged in the material supply line,
an actively driveable mixing device arranged in the mixing chamber, and
a mixing chamber outlet opening, wherein the mixing chamber extends along a longitudinal axis at least between the material supply opening and the mixing chamber outlet opening,
wherein the at least one additive line opens through an additive opening into the material supply line, wherein the additive opening is located upstream of the material supply opening.

20. The The 3D concrete printhead of claim 5, wherein the flow cross section constriction is in the form of a Laval nozzle.
